(19) United States
(12) Patent Application Publication
(10) Pub. No.: US 2024/0336144 A1
(43) Pub. Date: Oct. 10, 2024

(54) ELECTRICALLY DRIVEN MOTOR VEHICLE AND METHOD FOR OPERATION THEREOF

(71) Applicants: VOLKSWAGEN AG, Wolfsburg (DE); SIEMENS MOBILITY GMBH, München (DE)

(72) Inventors: Wolfgang Braun, Viereth-Trunstadt (DE); Klaus Dietrich, Grünheide (Mark) (DE); Hardy Naumann, Wolfsburg (DE); Wolfgang Hofheinz, Grünberg (DE); Henning Sebastian Vogt, Jembke (DE); Jürgen Hetzler, Offenbach (DE); Günter Uhl, Rohrbach (DE); Michael Zeyen, Herxheim (DE)

(21) Appl. No.: 18/576,927

(22) PCT Filed: Jun. 8, 2022
(86) PCT No.: PCT/EP2022/065555

§ 371 Date: Jan. 5, 2024

(30) Foreign Application Priority Data
Jul. 5, 2021 (DE) 10 2021 207 041.8

(51) Int. Cl. B60L 3/12; B60L 5/36

(52) U.S. Cl. CPC B60L 3/12; B60L 5/36; B60L 2210/10

(57) ABSTRACT

An electrically driven motor vehicle has current collectors for pickup from a dual-pole power transmission line device. A device determines the voltages between a vehicle chassis and the current collectors. The device is a bridge circuit with two equal voltage divider resistors connected in series between the two current collectors and a bridge shunt resistor electrically connected to a center tap between the voltage divider resistors and to the vehicle chassis, or the device has two voltage measurement devices for determining a voltage between the first current collector and the vehicle chassis and a voltage between the second current collector and the vehicle chassis. There is also described a method for operating the motor vehicle and a system with the motor vehicle and a dual-pole power transmission line device.

The invention relates to an electrically driven motor vehicle with two current collectors for a two-pole overhead line device, as well as to a method for operating the motor vehicle.

A motor vehicle is to be understood in this context as meaning a vehicle that is driven by a motor and is not connected to rails. As opposed to rail-bound or rail-guided vehicles, in which grounding takes place by means of the rails, in a motor vehicle a comparatively greater electrical resistance is present between the vehicle chassis (vehicle frame) and the subsurface, i.e. the ground, due to the tires of said vehicle.

By way of example, such a motor vehicle, which is supplied with electrical energy for the driving thereof on the basis of an overhead line device, is a catenary-operated bus (trolley bus) or a catenary-operated truck.

In order to avoid the risk of an electric shock (electrocution, electrical accident) for a person when coming into contact with the vehicle chassis, for this reason a voltage between the vehicle chassis and the subsurface should be as small as possible, in particular zero.

To this end, for example, the EN50502 standard is known for trolley buses, which essentially provides dual insulation (dual isolation) for electrical safety.

Furthermore, known from DE 639127 C is touch protection for trolley buses, wherein an electrical center point is established between the two current supply lines on the basis of auxiliary voltage sources, and wherein the electrical center point is connected to the car chassis to be brought to zero voltage by way of a further auxiliary voltage source.

Furthermore, a vehicle is known from EP 3 036 127 B1 which, to avoid hazardous contact voltages on the vehicle frame thereof, has a second protection level, which is formed by an installation of the traction drive to the vehicle frame in a manner with simple electrical insulation, as well as a first protection level, which is additionally formed by a galvanically isolating DC voltage converter connected between current collector and traction drive. The vehicle furthermore comprises a switch element, by means of which the protection system can be switched between the first and the second protection level by optionally connecting or bypassing the DC voltage converter. In this context, the bypass operation, in which the DC voltage converter is bypassed, is used at higher vehicle speeds, wherein the risk for persons outside due to the moving vehicle is rated higher compared to the risk due to an insulation fault.

The object underlying the invention is to specify an electrically driven motor vehicle, which has current collectors for electrically contacting overhead lines of an overhead line device. In particular, in this context, protection for a person against an electric shock when touching the vehicle chassis should be comparatively high and/or this protection should have comparatively low technical outlay. In this context, this protection should be implemented both when the motor vehicle is at a standstill and during travel operation, in particular independently of a speed of the vehicle operation. Furthermore, a method for operating such an electrically driven motor vehicle should be specified, as well as a system with such and with a two-pole overhead line device.

In relation to the electrically driven motor vehicle, the object is achieved according to the invention by the features of claim 1. With regard to the method, the object is achieved according to the invention by the features of claim 8, and in relation to the system by the features of claim 10. Advantageous embodiments and developments are the subject matter of the subclaims. In this context, the embodiments in connection with the electrically driven motor vehicle analogously also apply to the method and to the system, and vice versa.

The electrically driven motor vehicle, also referred to as vehicle for short in the following, has a vehicle chassis (a vehicle frame). In particular, the vehicle chassis is not grounded. Thus, the vehicle chassis is merely in contact with the subsurface of the vehicle by means of tires, wherein the tires have a comparatively high electrical resistance.

An electrically driven motor vehicle is to be understood in this context as meaning both a merely electrically driven motor vehicle, as well as a hybrid vehicle, i.e. motor vehicle which has further drive possibilities in addition to the electrical drive.

Furthermore, the vehicle comprises a first current collector as well as a second current collector. These two current collectors are used for electrical contacting with the two overhead lines of a two-pole overhead line device. To this end, each of the current collectors, which for example are embodied as pantographs, have a contact device, for example a contact strip or a contact reel. On the basis of the current collector, electrical energy provided by the overhead line device is to be used, in particular for a drive of the vehicle, and/or it is made possible to do so. In summary, the two current collectors are used for the supply of electrical energy externally (of the vehicle). In this context, the vehicle chassis is likewise electrically insulated in relation to the current collectors.

The electrically driven motor vehicle is in this context in particular provided to be used with such a two-pole overhead line device with two overhead lines, which are in particular embodied as catenaries, in which a voltage between the first of the two overhead lines and the ground potential is equal to the voltage between the ground potential and the second of the two overhead lines. The voltage applied to the overhead lines of an overhead line device of this kind thus has a symmetrical grounding, in other words with a centered voltage. The two overhead line voltages are thus symmetrical to the ground.

The vehicle also comprises a device for determining the voltage between the vehicle chassis and the first current collector and/or for determining the voltage between the vehicle chassis and the second current collector.

According to a first variant of the vehicle, this device is formed by means of a bridge circuit, in particular by means of a Wheatstone bridge circuit. This in turn comprises a voltage divider with two electrical voltage divider resistors (voltage divider resistance elements) that are interconnected in series with one another. In this context, the voltage divider is arranged between the first and the second current collector, and thus is electrically connected thereto. In this context, the voltage divider is embodied in such a manner that the two voltage divider resistors thereof have the same electrical resistance. This means that the absolute value of the electrical resistance (ohmic resistance) of the one voltage divider resistor is equal to the absolute value of the electrical resistance (ohmic resistance) of the other of the two voltage divider resistors. Thus, a voltage divider is formed with a fixed (constant) 1:1 dividing ratio. This voltage divider is also referred to here and in the following as reference voltage divider.

The second voltage divider of the bridge circuit is formed on the basis of the insulation (insulation material) between the first current collector and the vehicle chassis and on the basis of the insulation (insulation material) between the second current collector and the vehicle chassis. This second voltage divider is also referred to as insulation voltage divider.

In this context, a bridge cross resistor is connected between the branch of the measuring bridge formed on the basis of the reference voltage divider and a branch of the measuring bridge formed on the basis of the insulation. The bridge cross resistor is therefore electrically connected to a first center tap between the two voltage divider resistors, i.e. to a center point of the reference voltage divider. The bridge cross resistor is also electrically connected to the vehicle chassis or can be connected on the basis of a switch that is connected between the bridge cross resistor and the vehicle chassis. In summary, the bridge cross resistor is connected between the first center tap and the vehicle chassis.

Provided that the overhead line voltage is symmetrical to the ground, the overhead lines are electrically contacted with the respective current collector, provided that the insulation of the current collectors in relation to the vehicle chassis is symmetrical, and possibly provided that the switch connected between the center tap and the vehicle chassis is connected in a conductive manner, the vehicle chassis and the center point of the voltage divider have the same potential due to said electrical connection, and possibly when the switch is connected in a conductive manner. The center point of the voltage divider and the vehicle chassis electrically contacted with the center tap are therefore particularly advantageously at ground potential, or merely have a negligibly small voltage difference from the ground potential that does not represent a risk for a person should they touch the vehicle chassis. There is therefore no (touch) voltage present between the vehicle chassis and the ground which is hazardous for a person. A comparatively high level of safety in relation to an electric shock is therefore implemented for a person touching the vehicle chassis.

A symmetrical insulation is to be understood in this context as meaning that, with regard to the absolute value thereof, the electrical (ohmic) resistance of the insulation between the first current collector and the vehicle chassis is equal to the electrical (ohmic) resistance of between the second current collector and the vehicle chassis.

Particularly advantageously, there is also no touch voltage between the vehicle chassis and the ground in the event of symmetrical insulation faults. A 18 symmetrical insulation fault is to be understood in this context as meaning that an electrical resistance of the insulation between the first current collector and the vehicle chassis and an electrical resistance of the insulation between the second current collector and the vehicle chassis change, in particular reduce, by the same value, for example due to damage.

By contrast, an asymmetrical insulation fault, i.e. an insulation fault in which the electrical resistance of the insulation between the first current collector and the vehicle chassis and the electrical resistance of the insulation between the second current collector and the vehicle chassis do not change by the same value, can result in a touch voltage that can be hazardous for a person should they touch the vehicle chassis. Advantageously, however, such an asymmetrical insulation fault can be detected or identified on the basis of the device for determining the voltage between the vehicle chassis and the first current collector and/or the voltage between the vehicle chassis and the second current collector. In this first variant of the motor vehicle, this asymmetrical insulation fault can be detected at a voltage dropping over the bridge cross resistor.

In summary, with an overhead line voltage that is symmetrical in relation to the ground potential, a measure is implemented without voltage source, in which the vehicle chassis has ground potential and a touch voltage associated therewith is avoided. In this context, the voltage divider presented above has comparatively low technical outlay, meaning that, particularly compared with dual insulation, costs are lowered and weight and necessary installation space are reduced.

According to a second variant of the vehicle, the device has at least two voltage measurement devices. These are used to ascertain the voltage between the first current collector and the vehicle chassis as well as to ascertain the voltage between the second current collector and the vehicle chassis. To this end, the two voltage measurement devices are either connected in such a manner that these are able to directly detect these two voltage, or alternatively, the two voltage measurement devices are connected in such a manner that the voltage between the first and the second current collector can be detected by means of one of the two voltage measurement devices, and the voltage between the vehicle chassis and one of the two current collectors can be detected on the basis of the other voltage measurement device. In this embodiment, the absolute value of the voltage between the other of the current collectors and the vehicle chassis can then be ascertained on the basis of the difference between the voltage between the current collectors and the detected voltage between the vehicle chassis and the current collector.

Advantageously, it is possible to ascertain whether the vehicle chassis is at ground potential on the basis of the difference between the absolute value of the ascertained voltage between the first current collector and the vehicle chassis and the absolute value of the ascertained voltage between the second current collector and the vehicle chassis. With the assumption that the overhead line voltage is symmetrical to the ground, the vehicle chassis is then at ground potential when this difference is equal to zero (0).

In both variants, in summary, it is advantageously made possible to detect whether the vehicle chassis is at ground potential, wherein no direct (low-impedance) contact is present between the vehicle chassis and the ground, i.e. with the center point of the overhead line device (overhead line installation).

According to one advantageous embodiment, a first circuit and a second circuit are provided, the (electrical) resistance of which can be set in each case. The first and the second circuit are also referred to as setting device here and in the following. In this context, the first circuit and the second circuit are connected in series with one another and this series connection is connected between the two current collectors.

In the first and/or in the second variant of the motor vehicle, a second center tap is arranged between the first circuit and the second circuit, wherein the second center tap is connected to the vehicle chassis or preferably can be connected to the vehicle chassis on the basis of a switch, in a suitable manner on the basis of the switch connected between the bridge cross resistor and the vehicle chassis. In this preferred embodiment, at least the reference voltage divider, the bridge cross resistor and/or the first and the second circuit can therefore be electrically isolated from the vehicle chassis. Consequently, it is avoided that an insulation monitor, in particular a traction battery, identifies the setting device as an insulation fault from the first and the second circuit during battery operation of the motor vehicle.

For example, the first and the second circuit are in each case formed on the basis of a settable resistance. In an alternative and preferred manner, these in each case comprise at least one semiconductor component, which is in particular embodied as a controllable resistor or as a semiconductor switch, and/or a voltage source.

On the basis of the setting of the resistances of the two circuits, it is advantageously made possible to align a total resistance between the first current collector and the vehicle chassis with a total resistance between the second current collector and the vehicle chassis. When the switch between the second center tap and the vehicle chassis is closed, the respective total resistance in this context is produced from the first settable resistance, the voltage divider resistor, which is connected between the first current collector and the first center tap, of the reference voltage divider as well as from the electrical resistance of the insulation between the first current collector and the vehicle chassis or from the second settable resistance, the voltage divider resistor, which is connected between the second current collector and the first center tap, as well as from the electrical resistance of the insulation between the second current collector and the vehicle chassis.

On the basis of this adaptation, it is advantageously possible to compensate for an asymmetrical insulation fault, in which the electrical resistance of the insulation between the first current collector and the vehicle chassis and the electrical resistance of the insulation between the second current collector and the vehicle chassis has not changed by the same absolute value, for example due to damage.

In an expedient manner, the first circuit and the second circuit are connected in series with one another, wherein the center tap of the insulation voltage divider, i.e. the voltage divider formed on the basis of the insulation, is electrically connected to the second center tap or can be connected on the basis of the or a switch.

The first circuit and/or the second circuit are set as a function of the voltage dropping over the bridge cross resistor in the first variant of the motor vehicle or as a function of the voltages detected by the voltage measurement devices in the second variant of the motor vehicle. The total resistances in overhead line operation can thus be adapted. Expediently, the resistances of the circuits are set in such a manner that the electrical total resistance between the first current collector and the vehicle chassis is equal to the second electrical total resistance between the second current collector and the vehicle chassis. Associated with this, the voltage at the vehicle chassis is also set to ground potential. This is also referred to as (active) balancing of the vehicle chassis. As a consequence of this, a (touch) voltage between the vehicle chassis and the ground is also avoided in the case of asymmetrical insulation faults. 2

In summary, protection for a person against an electric shock when they touch the vehicle chassis is also advantageously implemented during overhead line operation.

Expediently, the first current collector and the second current collector are connected to a DC voltage converter, in particular on the input side. The traction battery is connected to the DC voltage converter, in particular on the output side of the DC voltage converter. For example, electrical consumers, in particular an electric motor for driving the vehicle, are connected to the traction battery.

In an advantageous embodiment, a switch, in particular embodied as a contactor, is in each case connected both between the contact device of the first current collector and the DC voltage converter, in particular in a high-voltage current path that runs therebetween, and between the contact device of the second current collector and the DC voltage converter, in particular in a further high-voltage current path that runs therebetween. In other words, the switch is in each case arranged in a current collector current path from the contact device of the assigned current collector to the DC voltage converter.

These are used to produce an electrically conductive connection and/or to interrupt the high-voltage current path, which runs from the respective current collector to the rest of the vehicle. As an alternative to this, or preferably in addition to this, these two switches are connected as a function of the voltage dropping at the bridge cross resistor (first variant of the motor vehicle) or as a function of the voltages ascertained on the basis of the voltage measurement devices (second variant of the motor vehicle), and/or as a function of the electrical resistance of the first and/or second circuit (both variants of the motor vehicle).

In an advantageous embodiment, the DC voltage converter is a DC voltage converter without galvanic isolation, i.e. with galvanic coupling. A DC voltage converter with galvanic isolation offers an additional protective measure, in particular for dual insulation in the sense of EN50502. However, due to the balancing of the vehicle chassis, a DC voltage converter with galvanic isolation is not necessary for sufficient protection of the user from an electric shock. Compared to the use of a DC voltage converter with galvanic coupling, there is a saving of costs, installation space and/or weight here.

In particular, where the DC voltage converter is a galvanically coupled DC voltage converter, according to an advantageous embodiment of the motor vehicle in the first or the second variant, additionally or alternatively to the first and second circuit, a third and a fourth circuit are provided, the electrical (ohmic) resistances of which can be set. In analogy to the first and the second circuit, the third or fourth circuit is for example in each case formed on the basis of a settable resistance or preferably comprises at least one semiconductor component, which is in particular embodied as a controllable resistor or as a semiconductor switch, and/or a voltage source.

If necessary, the third circuit is connected between a first high-voltage current path, which is connected on the one hand to a first battery terminal of a traction battery of the motor vehicle and on the other hand, in particular on the output side, to the DC voltage converter, and the vehicle chassis. In particular, this high-voltage current path therefore runs between the first battery terminal (for example positive pole) and the DC voltage converter. The fourth circuit is connected between the vehicle chassis and a second high-voltage current path, which is connected to a second battery terminal of the traction battery and the DC voltage converter, which second high-voltage current path in particular therefore runs between the second battery terminal (for example the negative pole) and the DC voltage converter.

In an analogous manner to the first and the second circuit, the total resistances between the current collectors and the vehicle chassis can be adapted to one another on the basis of the third and/or fourth circuit. The first circuit is also referred to as first balancing or first setting circuit, the second circuit is also referred to as second balancing or second setting circuit, the third circuit is also referred to as third balancing or third setting circuit and the fourth circuit is also referred to as fourth balancing or fourth setting circuit. 2

A further aspect of the invention relates to a method for operating a motor vehicle, which is embodied according to one of the variants presented above. In this context, during overhead line operation of the (motor) vehicle according to the first variant, it is ascertained whether the Wheatstone measuring bridge formed on the basis of the reference voltage divider, on the basis of the insulation between the first current collector and the vehicle chassis, on the basis of the insulation between the second current collector and the vehicle chassis, on the basis of the first and second circuit, as well as on the basis of the bridge cross resistor is balanced. To this end, a voltage dropping over the bridge cross resistor or a bridge current between the bridge branches, in particular a current through the bridge cross resistor, is detected. If the vehicle is embodied according to the second variant, then during overhead line operation, the voltages between the first current collector and the vehicle chassis as well as the voltage between the second current collector and the vehicle chassis are detected or ascertained on the basis of the voltage measurement devices. If the bridge is not balanced, i.e. the voltage dropping at the bridge cross resistor or the bridge current is not equal to zero (0) (first variant of the motor vehicle) or the voltage between the first current collector and the vehicle chassis is not equal to the voltage between the vehicle chassis and the second current collector (second variant of the motor vehicle), then the electrical resistance of the first, the second, the third and/or the fourth circuit is set or regulated in such a manner that the bridge is balanced, wherein the respective electrical resistance is preferably reduced.

Particularly preferably, a threshold value or a threshold value in each case for the absolute value of the electrical resistance of the first, second, third or fourth circuit is predefined or predefinable, wherein the overhead line operation is ended when the respective threshold value is fallen below, i.e. the two switches, which are connected between the contact device of the respective current collector and the DC voltage converter, are switched to current-blocking. In this manner, it is avoided that the absolute value of the electrical resistance between the vehicle chassis and the corresponding current collector becomes too small.

In an analogous manner, a threshold value or a threshold value in each case for the absolute value of the electrical resistance of the first, second, third or fourth circuit can also be predefined or predefinable, wherein the overhead line operation is ended when the respective threshold value is exceeded. Thus, an (excessively) high resistance can indicate a faulty/defective circuit.

In summary, the first circuit, the second circuit, the third circuit and/or the fourth circuit is therefore set or regulated in such a manner that a first electrical total resistance between the first current collector and the vehicle chassis is equal to a second electrical total resistance between the second current collector and the vehicle chassis.

Preferably, in addition, in the first variant of the motor vehicle, when a (further) predefined or predefinable threshold value is exceeded by the voltage dropping over the bridge cross resistor or by the current flowing through the bridge cross resistor, or, in the second variant of the motor vehicle, by a difference between the ascertained voltages between the first current collector and the vehicle chassis or between the second current collector and the vehicle chassis, the two switches, which are connected between the contact device of the respective current collector and the DC voltage converter, are switched to current-blocking. In other words, the contact line operation is ended.

In this manner, asymmetrical insulation faults can be identified and an electrical connection of the vehicle chassis to the respective contact device and, associated therewith, to the overhead line can be interrupted. For example, the vehicle can subsequently be operated in battery operation and, in particular, can continue to travel in battery operation.

In particular, it is thus possible to compensate for asymmetrical insulation faults, at least partially, with symmetrical overhead line voltage.

A further aspect of the invention relates to a system consisting of an electrically driven motor vehicle, which is embodied according to one of the variants presented above, and/or according to the method in one of the variants presented above.

Furthermore, the system comprises a two-pole overhead line device with two overhead lines, wherein a voltage between a first of the two overhead lines and the ground is equal to the voltage between the ground and the second of the two overhead lines. This is achieved, for example, by a grounding that is symmetrical, i.e. with a centered voltage, in the substation of the overhead line device.

In comparison thereto, in a substation in which one of the overhead lines is connected to ground, grounding of the vehicle chassis or alternatively dual insulation is necessary, if the DC voltage converter has a galvanic coupling.

Exemplary embodiments of the invention are explained in greater detail below with reference to a drawing, in which:

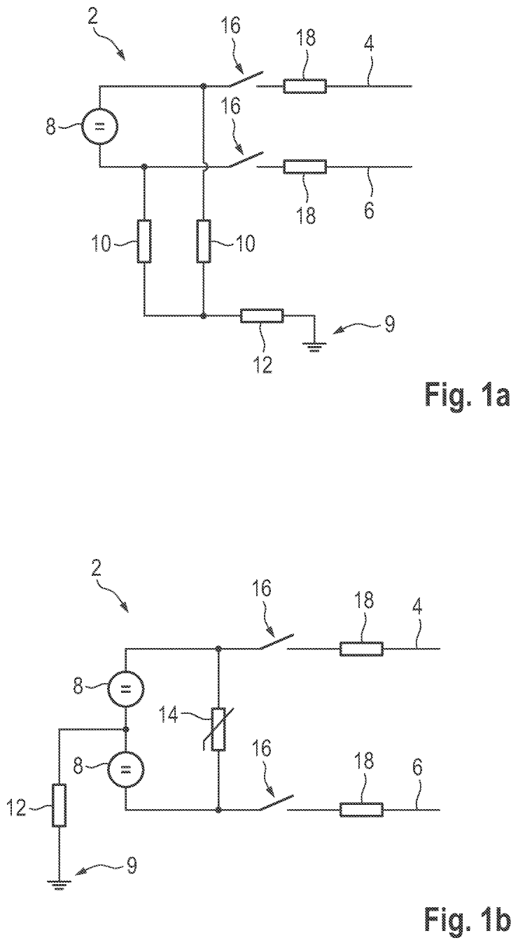

FIGS. 1a,b show different embodiments of an overhead line device with two overhead lines for supplying an electrically driven motor vehicle with electrical energy,

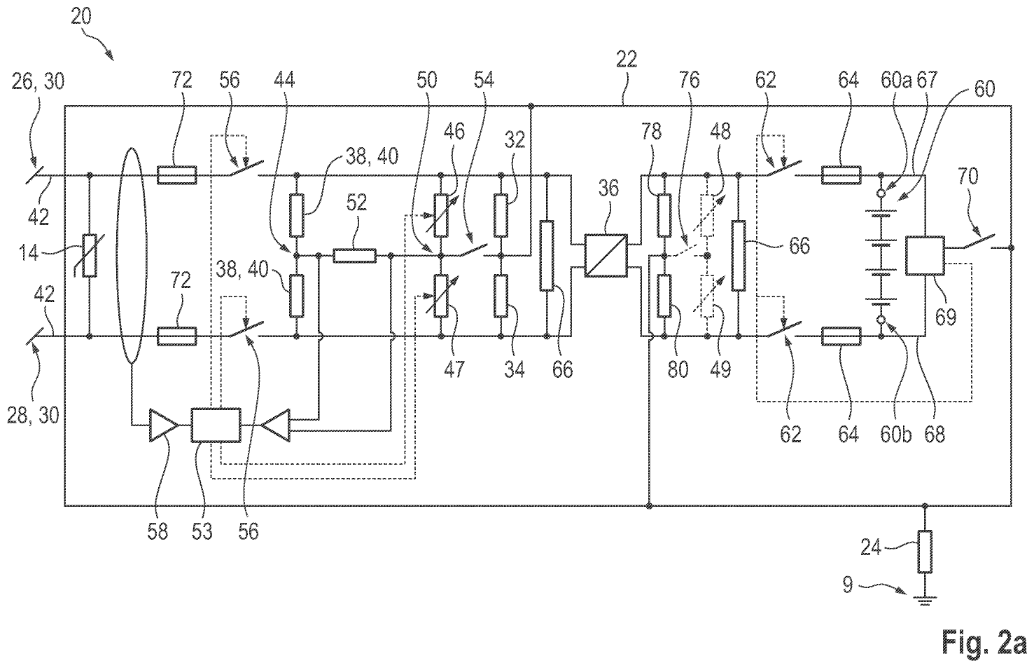

FIG. 2a shows a first variant of an electrically driven motor vehicle with two current collectors, between which two voltage divider resistors that are connected in series are connected, wherein a center tap between the voltage divider resistors is connected to the vehicle chassis,

FIG. 2b shows a second variant of the electrically driven motor vehicle, wherein it has a voltage measurement device for detecting a voltage between the two current collectors as well as a voltage measurement device for detecting the voltage between the vehicle chassis and one of the two current collectors, and

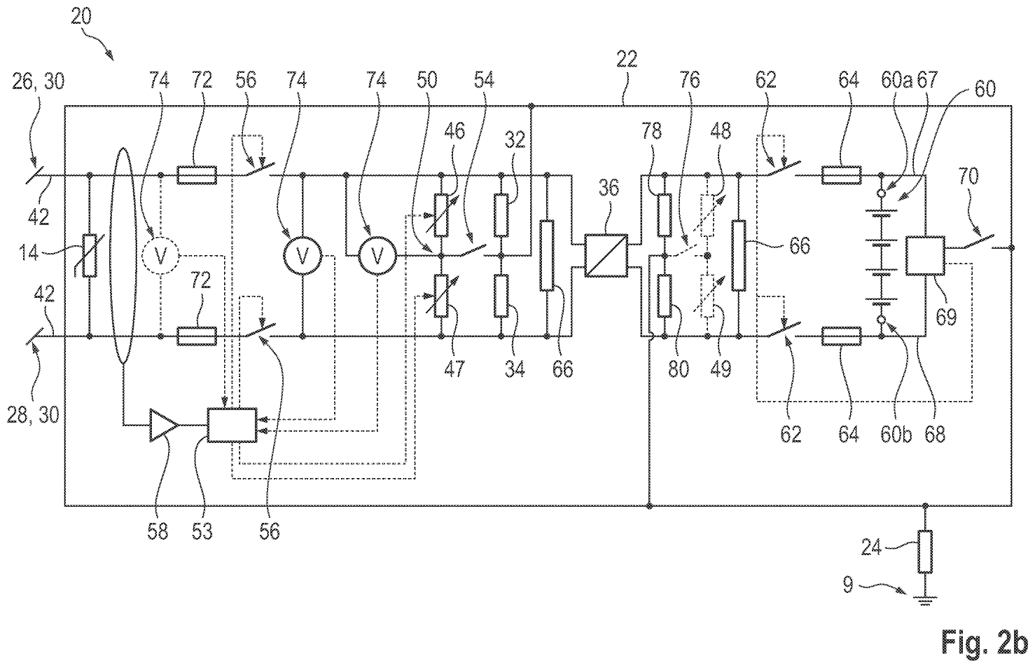

FIG. 3 shows a flow diagram of a method sequence for operating the electrically driven motor vehicle.

Parts and variables which correspond to one another are provided with the same reference characters in all the figures in each case.

FIGS. 1a and 1b show two embodiments of an overhead line device 2 (overhead line installation). This is embodied, for example, as a catenary device. What the two embodiments have in common is that the overhead line device 2 has two overhead lines that are embodied in particular as catenaries, specifically a first overhead line 4 and a second overhead line 6. Furthermore, the overhead line device 2 comprises a substation, of which the DC voltage source 8 (FIG. 1a) or the DC voltage sources 8 are shown in the figures, in sections. In this context, the overhead lines 4 and 6 are interconnected in such a manner that a voltage between the first overhead line 4 and the ground 9 is equal to the voltage between the ground 9 and the second overhead line 6. The two overhead line voltages are thus symmetrical to the ground. In summary, a grounding with a centered voltage is implemented in the substation. The DC voltage source(s) are expediently in each case formed by means of at least one transformer and at least one rectifier connected downstream thereof.

To this end, according to the embodiment in FIG. 1a, one end (output) of the DC voltage source 8 is connected to the first overhead line 4 and the other end (output) of the DC voltage source 8 is connected to the second overhead line 6. In this context, the first overhead line 4 and the second overhead line 6 are in each case connected to ground 9 by means of a balancing resistor 10. The electrical resistance of the balancing resistors in this context amounts to 1 kΩ in each case, for example. The power loss resulting between the two overhead lines 4 and 6 with a voltage of 1200 V, for example, is comparatively low in this case. Insensitivity to asynchronous harmonics of the current source is also an advantage of this embodiment.

Optionally, on the substation side, an overvoltage protection is provided between the two overhead lines 4, 6 and/or an overhead line safety device, in particular a switching device with overcurrent and short-circuit functionality, is provided in each case for each of the overhead lines 4 and 6, in analogy to FIG. 1b.

Alternatively to the embodiment of the overhead line device 2 according to FIG. 1a, the substation has two DC voltage sources 8 with the same output voltage, which are connected in series, for grounding with a centered voltage, wherein a center tap is connected to ground 9 between the two DC voltage sources 8, cf. FIG. 1b. In particular, the center tap is arranged on the secondary side, i.e. between the two DC voltage sources 8. The ground resistance is provided with the reference character 12 in this case.

In the embodiment of the overhead line device 2 according to the FIG. 1b, optionally, on the substation side, an overvoltage protection 14 is also provided between the two overhead lines 4, 6 and/or an overhead line safety device (not shown) and/or a switching device 16 with overcurrent and short-circuit functionality is provided for each of the overhead lines 4 and 6.

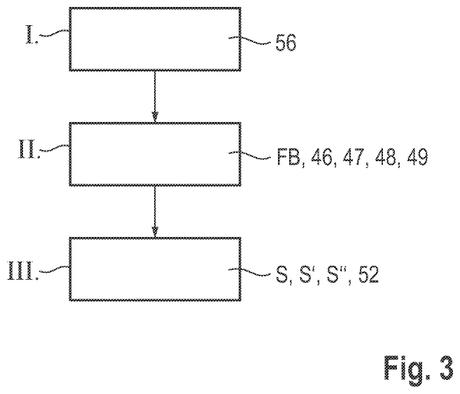

In FIGS. 1a and 1b, 18 refers to the overhead line resistance of the respective overhead line 4 or 6. For example, this amounts to 100 mΩ/km.

FIG. 2a schematically shows a first variant of an electrically driven motor vehicle 20. This is provided and configured to be used with an overhead line device 2, for example according to FIG. 1a or 1b, wherein the voltage between the first overhead line 4 and the ground 9 is equal to the voltage between the ground 9 and the second overhead line 6.

The vehicle chassis 22 of the vehicle 20 is not grounded, wherein contact with the ground 9 is merely established on the basis of tires, which are filled with air for example, with comparatively high resistance 24 that acts in an electrically insulating manner. Furthermore, the vehicle 20 has a first current collector 26 as well as a second current collector 28. Each of the current collectors 26 and 28 comprises a contact device 30, which is embodied as a contact strip for example, for contacting one of the overhead lines 4 or 6 in each case.

The electrical insulation (isolation) between the first current collector 26 and the vehicle chassis 22 as well as the electrical insulation (isolation) between the second current collector 28 and the vehicle chassis are each shown in FIG. 2 on a representative basis with an electrical (insulation) resistance, which are provided with the reference characters 32 and 34.

The two current collectors 26 and 28 are connected to a galvanically non-isolating DC voltage converter 36 by means of a switch 56 in each case, i.e. are electrically connected thereto. The DC voltage converter 36 is a unidirectional or a bidirectional buck-boost converter, for example. In other words, the switch 56, in particular embodied as a contactor, is in each case connected between the contact device 30 of the first current collector 26 and the DC voltage converter 36, as well as between the contact device 30 of the second current collector 28 and the DC voltage converter 36. In other words, the switch 56 is connected in a high-voltage current path 42, which is in particular embodied as a high-voltage conductor rail and which runs between the contact device 30 of the respective current collector 26 or 28 and the DC voltage converter 36.

A (reference) voltage divider 38 is connected between the high-voltage current paths 42 starting from the two current collectors 26 and 28. This comprises two voltage divider resistors 40, which are connected in series with one another and have the same ohmic resistance. In other words, a voltage divider with a 1:1 dividing ratio is implemented on the basis of the voltage divider resistors 40. The voltage divider resistors 40 have an ohmic resistance that is preferably greater than 10 kΩ, in particular greater than 50 kΩ, preferably between 100 kΩ and 1 MΩ, for example 500 kΩ.

In this context, the (reference) voltage divider 38 is connected to the high-voltage current paths 42. A center tap 44 at the voltage center point of the voltage divider 38, i.e. at a tap between the two voltage divider resistors 40, is electrically connected to the vehicle chassis 22 when switch 54 is switched to current-conducting.

In summary, on the basis of the reference voltage divider 38, the bridge cross resistor 52 and the insulation (resistances 32,34), a bridge circuit is implemented in the manner of a Wheatstone measuring bridge. The insulation (resistances 32,34) in this case form an (insulation) voltage divider, i.e. a branch of the 4 measuring bridge. The reference voltage divider 38 is the reference path for the voltage measurement of the measuring bridge. The motor vehicle therefore 6 comprises a device for determining the voltage between the vehicle chassis 22 and the first current collector 26 and/or the voltage between the vehicle chassis 22 and the second current collector 28, wherein the device is formed by means of the bridge circuit.

Furthermore, the motor vehicle comprises a first circuit 46, the electrical resistance of which can be set, as well as a second circuit 47, the electrical resistance of which can be set. For the sake of clarity, the two circuits 46, 47 are shown as settable resistors. These comprise, for example, a number of semiconductor elements, in a suitable manner one or more in the form of a transistor, such as a MOSFET for example, in which in each case it is possible for setting to take place on the basis of the gate-source voltage of the electrical resistance of the drain-source path. The circuits 46,47 are connected between the two high-voltage current paths 42, which in turn can be connected to the contact devices 30 on the basis of the switches 56. In this case, a second center tap 50 between the two circuits 46 and 47 is electrically connected to the center tap 44 of the voltage divider 38 from the voltage divider resistors 40 via a bridge cross resistor 52. In summary, a bridge cross resistor 52 is connected between the center taps 44, 50. A voltage possibly dropping at the bridge cross resistor can be detected, and a value that represents it or a corresponding signal can be output to a control unit 53.

By setting the resistance of the first and/or the second circuit 46,47, during overhead line operation of the motor vehicle 20 it is possible for the total resistance between the first current collector 26 and the vehicle chassis 22 to be aligned with a total resistance between the second current collector 28 and the vehicle chassis 22. The voltage divider formed on the basis of the first and second circuit 46,47 is also referred to as setting voltage divider, as compensation voltage divider or as balancing voltage divider.

In a suitable manner, the ohmic resistance of the circuits 46 and 47 are in each case set between 10 kΩ and 10 MΩ.

Furthermore, the further switch 54 is connected between the vehicle chassis 22 and the center tap 50 of the circuits 46 and 47, meaning that these, as well as the voltage divider 38, can be disconnected during battery operation of the motor vehicle 20. When the switch 54 is switched to current-conducting, the voltage at the vehicle chassis 22 corresponds to the voltage at the second center tap 50.

According to a variant that is not represented in more detail, the switches 56 in the respective high-voltage current path 42 are connected between the DC voltage converter 36 and the connection point of the circuits 46,47.

Optionally, a differential current measuring device 58 is coupled to the control unit. This detects a differential current between the current through the two high-voltage current paths 42, meaning that the switches 56 can be switched to current-blocking when the differential current exceeds a certain threshold value.

Furthermore, a traction battery 60 is connected to the DC voltage converter 36. In this case, a battery contactor 62 as well as a battery safety device 64 are connected between the poles of the traction battery 60 and the DC voltage converter 36 in each case. Furthermore, a consumer 66, which is represented here as a resistor, for example an electric motor for driving the motor vehicle 20, is connected to the traction battery 60. In addition or as an alternative to this, the or a consumer 66 is connected on the DC voltage converter side of the switch 56 between the current collectors 26 and 28.

In addition or as an alternative to the circuits 46, 47, the motor vehicle has a third circuit 48, which is represented by a dashed line in FIGS. 2a and 2b, and a fourth circuit 49, which is represented by a dashed line. The third circuit 48 in this case is connected between a high-voltage current path 67, which runs between a first battery terminal 60a and the DC voltage converter 36, and the vehicle chassis 22. The fourth circuit 49 is connected between a high-voltage current path 68, which runs between a second battery terminal 60b and the DC voltage converter 36, and the vehicle chassis 22. The third and fourth circuit 48,49 in this case can be electrically connected to the vehicle chassis 22 on the basis of a switch 76. To this end, the switch 76 is connected between a center tap, which is arranged between the third and fourth circuit 48,49, and the vehicle chassis 22.

The electrical resistance of the third and the fourth circuit 48,49 can be set in an analogous manner to the first and the second circuit 46,47, meaning that on the basis of the first, the second, the third and/or the fourth circuit 46, 47, 48, 49 it is possible for the total resistance between the first current collector 26 and the vehicle chassis 22 to be aligned with a total resistance between the second current collector 28 and the vehicle chassis 22.

The insulation between the high-voltage current path 67 and the vehicle chassis is represented, in an analogous manner to the electrical resistance 32 in FIGS. 2a and 2b, on the basis of a resistance element 78 connected between said high-voltage current path 67 and the vehicle chassis 22. The insulation between the high-voltage current path 68 and the vehicle chassis 22 is likewise shown on a representative basis, in an analogous manner to the electrical resistance 34, on the basis of a resistance element 80 connected between the high-voltage current path 68 and the vehicle chassis 22.

The traction battery 60 and the elements connected thereto are electrically insulated in relation to the vehicle chassis 22. The traction battery 60 has an insulation monitor 69. If a fault in the insulation of the traction battery 60 is detected, then the battery contactors 62 are opened. During overhead line operation, the insulation monitor 69 can be deactivated by opening a switch 70.

Furthermore, an overvoltage protection 14 is connected between the two current collectors 26 and 28. Furthermore, a current collector safety device 72 is connected between the contact unit 30 of the respective current collector 26, 28 and the DC voltage converter 36.

FIG. 2b shows a second variant of the electrically driven motor vehicle 20. This variant differs from the first variant according to FIG. 2a in that the device for determining the voltage between the vehicle chassis 22 and the first current collector 26 and/or for determining the voltage between the vehicle chassis 22 and the second current collector 28 comprises two voltage measurement devices 74. According to the embodiment shown here, the voltage measurement devices 74 are connected in such a manner that it is possible to detect the voltage between the current collectors 26, 28 as well as the voltage between the first current collector 26 and the vehicle chassis 22. To this end, one of the voltage measurement devices 74 is connected between the high-voltage current path 42, which is connected to the first current collector, and the vehicle chassis, while the other of the voltage measurement devices 74 is connected between the two high-voltage current paths 42. In this case, said voltage measurement device 74 can be connected to the high-voltage current paths 42 on the DC voltage converter side or on the current collector side, i.e. on the contact device side, in relation to the switches 56. The connection of the voltage measurement device 74 on the current collector side is shown in FIG. 2b by said voltage measurement device being represented by a dashed line.

According to an alternative that is not represented in more detail, the two voltage measurement devices 74 are connected in such a manner that it is possible to detect the voltage between the first current collector 26 and the vehicle chassis 22 as well as the voltage between the second current collector 28 and the vehicle chassis. According to a further alternative that is not represented in more detail, the two voltage measurement devices 74 are connected in such a manner that it is possible to detect the voltage between the current collectors 26, 28 as well as the voltage between the second current collector 26 and the vehicle chassis 22.

The switch 54 is optional in this second variant. In particular, it can be dispensed with if the resistances in the circuits are set in a comparatively high-ohmic manner, for example in each case greater than 1 kΩ, in a suitable manner greater than 5 kΩ, in an expedient manner greater than 10 kΩ, or greater than 50 kΩ, preferably between 100 kΩ and 1 MΩ, or can be set in such a high-ohmic manner.

Otherwise, the statements in relation to FIG. 2a apply in an analogous manner.

The vehicle 20 according to FIG. 2a or FIG. 2b and the overhead line device 2 form a system.

FIG. 3 shows a method sequence for operating the motor vehicle 20 on the basis of a flow diagram. This has the first circuit 46, the second circuit 47, the third circuit 48 and/or the fourth circuit 49.

In a first step I., the contact devices 30 of the current collectors 26,28 are moved in such a manner that these are in contact with the overhead lines 4,6 of the overhead line device 2. In other words, the current collectors 26,28 are coupled to the overhead lines 4,6. In this context, the switches 56 are in the open, i.e. non-conductive, state.

For example, the overhead line voltage is ascertained or detected on the basis of the voltage measurement devices 74. Furthermore, in step I.—where necessary—a precharging of the vehicle network on the current collector side takes place by means of the DC voltage converter 36 and the traction battery 60. At the start of overhead line operation FB, in particular catenary operation, the switches 56 are then closed, i.e. switched to current-conducting.

During overhead line operation FB, in a second step II., in the first variant of the motor vehicle 20, a voltage dropping over the bridge cross resistor 52 or, in an analogous manner, a bridge current in the bridge cross branch is detected or, in the second variant of the motor vehicle 20, the voltage between the first current collector 26 and the vehicle chassis 22 as well as the voltage between the second current collector 28 and the vehicle chassis 22 are ascertained on the basis of the voltage measurement device 74.

If the bridge is not balanced, i.e. the voltage dropping at the bridge cross resistor or the bridge current is not equal to zero (0) (first variant of the motor vehicle) or the voltage between the first current collector and the vehicle chassis is not equal to the voltage between the vehicle chassis and the second current collector (second variant of the motor vehicle), then in a second step II. the electrical resistance of the first, the second, the third and/or the fourth circuit 46 to 49 is set or regulated in such a manner that the bridge is balanced. In other words, the electrical resistance of the first, the second, the third and/or the fourth circuit 46 to 49 are then set or regulated in such a manner that the voltage dropping at the bridge cross resistor or the bridge current is equal to zero (first variant of the motor vehicle) or the voltage between the first current collector and the vehicle chassis is equal to the voltage between the vehicle chassis and the second current collector. In this state, the first electrical total resistance between the first current collector 26 and the vehicle chassis 22 is equal to a second electrical total resistance between the second current collector 28 and the vehicle chassis 22. As a consequence—with symmetrical overhead line voltage—the potential at the vehicle chassis 22 corresponds to the ground potential 9.

Furthermore, a threshold value S or a threshold value in each case for the absolute value of the electrical resistance of the first, second, third or fourth circuit 46 to 49 is predefined or predefinable, wherein the overhead line operation is ended when the electrical resistance of at least one of the circuits 46 to 49 falls below the threshold value S, i.e. the two switches 56, which are connected between the contact device 30 of the respective current collector 26,28 and the DC voltage converter 36, are switched to current-blocking (step III.). In this manner, it is avoided that the absolute value of the electrical resistance between the vehicle chassis and the corresponding current collector becomes too small.

For example, a further threshold value S′ or a threshold value S′ in each case for the absolute value of the electrical resistance of the first, second, third or fourth circuit 46 to 49 is predefined or predefinable, wherein the overhead line operation is ended when the electrical resistance of at least one of the circuits 46 to 49 exceeds the threshold value S′ (step III.).

For example, in addition to this, during overhead line operation FB, on the basis of the control unit 53, the voltage dropping over the bridge cross resistor 52 or a value, which is or was ascertained from the voltage detected (on the basis of the voltage measurement devices 74) between the first current collector 26 and the vehicle chassis 22 and from the voltage between the vehicle chassis 22 and the second current collector 28 is compared with a predefined or predefinable (further) (voltage) threshold value S″. If this threshold value is exceeded, then the overhead line operation FB is ended. This value is, for example, the difference between the detected voltages, the absolute value thereof, a ratio of said voltages or the absolute value thereof. To end the overhead line operation, in particular the two switches 56 are actuated by the control unit 53 in such a manner that these are switched to current-blocking (open). This is used as redundant protection for a person against an electric shock when touching the vehicle chassis 22.

If it is not possible to align the first total resistance to the second electrical total resistance on the basis of the circuits 46, 47, 48, 49, then the overhead line operation FB is expediently ended.

Expediently, step II. is performed on a temporally recurring basis during overhead line operation FB.

The invention is not restricted to the exemplary embodiments described above. Rather, other variations of the invention can also be derived therefrom by the person skilled in the art without departing from the subject matter of the invention. In particular it is furthermore also possible to combine all the individual features described in connection with the exemplary embodiments with one another in a different manner, without departing from the subject matter of the invention.

### LIST OF REFERENCE CHARACTERS

2 overhead line device
4 first overhead line
6 second overhead line
8 DC voltage source
9 ground
10 electrical resistance/balancing resistor
12 ground resistance
14 overvoltage protection
16 switching device with overcurrent and short-circuit functionality
18 electrical resistance of the overhead line
20 electrically driven motor vehicle
22 vehicle chassis
24 (tire) resistance
26 first current collector
28 second current collector
30 contact device
32 electrical resistance of the insulation
34 electrical resistance of the insulation
36 DC voltage converter
38 (reference) voltage divider
40 voltage divider resistor
42 high-voltage current path
44 center tap
46 first circuit
47 second circuit
48 third circuit
49 fourth circuit
50 second center tap
52 bridge cross resistor
53 control unit
54 switch
56 switch/contactor
58 differential current measuring device
60 traction battery
60a,b battery terminal
62 battery contactor
64 battery safety device
66 consumer
67 high-voltage current path
68 high-voltage current path
69 insulation monitor
70 switch
72 current collector safety device
74 voltage measurement device
76 switch
78 electrical resistance of the insulation
80 electrical resistance of the insulation
FB overhead line operation
S,S′,S″ threshold value
I. coupling the current collectors to the overhead lines
II. ascertaining whether measuring bridge is balanced and possibly setting the resistances of the circuits
III. comparing the resistances of the circuits with threshold value and possibly ending the overhead line operation

1-10. (canceled)

11. An electrically driven motor vehicle, comprising:
a first current collector for contacting a first overhead line of a two-pole overhead line device and a second current collector for contacting a second overhead line of the two-pole overhead line device;
a vehicle chassis; and
a measuring device for determining at least one of a voltage between said vehicle chassis and said first current collector or a voltage between said vehicle chassis and said second current collector;
said measuring device having a bridge circuit with two voltage divider resistors connected in series between said first and second current collectors, having the same electrical resistance and a first center tap therebetween, and said bridge circuit further including a bridge cross resistor that is electrically connected to said first center tap and said vehicle chassis or is connectible to said vehicle chassis via a switch; or
said measuring device including two voltage measurement devices that are configured to detect at least one voltage selected from the group consisting of a voltage between said first and second current collectors, a voltage between said first current collector and said vehicle chassis, and a voltage between said second current collector and said vehicle chassis.

12. The electrically driven motor vehicle according to claim 11, which comprises:
a first circuit having a settable electrical resistance;
a second circuit connected in series with said first circuit and having a settable electrical resistance;
said first circuit and said second circuit being connected between said first and second current collectors and having a second center tap therebetween; and
said second center tap being connected to said vehicle chassis or is connectible to said vehicle chassis via said switch or a further switch.

13. The electrically driven motor vehicle according to claim 12, which comprises a DC voltage converter connected to said first current collector and said second current collector.

14. The electrically driven motor vehicle according to claim 13, which comprises:
a traction battery having a first battery terminal and a second battery terminal;
a third circuit having a settable electrical resistance and a fourth circuit having a settable electrical resistance;
said third circuit being connected between a high-voltage current path, which runs between said first battery terminal of said traction battery and said DC voltage converter, and said vehicle chassis, and
said fourth circuit being connected between a high-voltage current path, which runs between said second battery terminal of said traction battery and said DC voltage converter, and said vehicle chassis.

15. The electrically driven motor vehicle according to claim 14,
wherein at least one of the resistance of said first circuit, the resistance of said second circuit, the resistance of said third circuit, or the resistance of said fourth circuit is set as a function of a voltage dropping over said bridge cross resistor or as a function of the voltages detected by said voltage measurement devices.

16. The electrically driven motor vehicle according the claim 14, which comprises:
a first switch connected in a high-voltage current path between a contact of said first current collector and said DC voltage converter and a second switch connected in a high-voltage current path between a contact of said second current collector and said DC voltage converter;
said first and second switches being connected as a function of the electrical resistance of at least one of said first circuit, said second circuit, said third circuit, or said fourth circuit, as a function of a voltage dropping over said bridge cross resistor, and/or as a function of a value which is ascertained from the voltages detected by said voltage measurement devices.

17. The electrically driven motor vehicle according to claim 16, wherein said switches are contactor switches.

18. The electrically driven motor vehicle according to claim 13, wherein said DC voltage converter is a DC voltage converter without galvanic isolation.

19. A method of operating an electrically driven motor vehicle, the method comprising:
providing a motor vehicle according to claim 11;
during overhead line operation, detecting a voltage dropping over the bridge cross resistor; or
during overhead line operation, ascertaining the voltage between the first current collector and the vehicle chassis and the voltage between the second current collector and the vehicle chassis by the voltage measurement devices; and
setting at least one of the first circuit, the second circuit, a third circuit, or a fourth circuit, to drive the voltage across the bridge cross resistor to a value equal to zero or to set the voltage between the first current collector and the vehicle chassis to be equal to the voltage between the vehicle chassis and the second current collector.

20. The method according to claim 19, wherein the setting step is a closed-loop control process.

21. The method according to claim 19, which comprises switching the first and second switches to current-blocking when:
the resistance of the first circuit, the resistance of the second circuit, the resistance of the third circuit, and/or the resistance of the fourth circuit falls below a predefined or predefinable threshold value; and/or
the resistance of the first circuit, the resistance of the second circuit, the resistance of the third circuit, and/or the resistance of the fourth circuit exceeds a further predefined or predefinable threshold value; and/or
a voltage dropping over the bridge cross resistor or a value, which is ascertained from the voltages detected on the basis of the voltage measurement devices, exceeds a further predefined or predefinable threshold value.

22. A system, comprising:
an electrically driven motor vehicle according to claim 11;
a two-pole overhead line device with two overhead lines, wherein a voltage between a first of said two overhead lines and ground is equal to a voltage between ground and a second of said two overhead lines.

23. The system according to claim 22, wherein:
during overhead line operation, a voltage dropping over the bridge cross resistor is determined; or
the voltage measurement devices are configured, during overhead line operation, to ascertain the voltage between the first current collector and the vehicle chassis and to ascertain the voltage between the second current collector and the vehicle chassis; and
at least one of the first circuit, the second circuit, a third circuit, or a fourth circuit, is set to drive the voltage across the bridge cross resistor to a value equal to zero or to set the voltage between the first current collector and the vehicle chassis to be equal to the voltage between the vehicle chassis and the second current collector.
